(19) United States
(12) Patent Application Publication
(10) Pub. No.: US 2016/0191359 A1
(43) Pub. Date: Jun. 30, 2016

(54) REACTIVE DIAGNOSTICS IN STORAGE AREA NETWORKS

(71) Applicant: HEWLETT PACKARD ENTERPRISE DEVELOPMENT LP, Houston, TX (US)

(72) Inventors: Satish Kumar MOPUR, Bangalore (IN); Shreyas MAJITHIA, Bangalore (IN); Kannantha SUMANTHA, Bangalore (IN); Akilesh KAILASH, Bangalore (IN); Krishna PUTTAGUNTA, Roseville, CA (US); Satyaprakash RAO, Shrewsbury, MA (US); Aesha Dhar ROY, Bangalore (IN); Ramakrishnaiah Sudha K R, Bangalore (IN); Ranganath Prabhu V V, Bangalore (IN); Chuan PENG, Houston, TX (US); Prakash Hosahally SURYANARAYANA, Bangalore (IN)

(73) Assignee: Hewlett Packard Enterprise Development LP, Houston, TX (US)

(21) Appl. No.: 14/910,219

(22) PCT Filed: Aug. 15, 2013
(86) PCT No.: PCT/US2013/055212

§ 371 Date: Feb. 4, 2016

(51) Int. Cl. H04L 12/26; H04L 29/08

(52) U.S. Cl. CPC H04L 43/0817; H04L 67/1097; H04L 43/045

(57) ABSTRACT

The present techniques relate to reactive diagnostics of a storage area network (SAN). In one implementation, the method for performing reactive diagnostics in the SAN comprises determining a topology of the SAN, wherein the SAN comprising devices and connecting elements to interconnect the devices. The method further comprises depicting the topology in a graph, wherein the graph designates the devices as nodes and the connecting elements as edges, and the graph comprises operations associated with at least one component of the nodes and edges. Thereafter, at least one parameter indicative of performance of the at least one component is monitored to ascertain degradation of the at least one component. The method further comprises performing reactive diagnostics for of the at least one component, to determine root cause of the degradation, based on the operations.

### BACKGROUND

Generally, communication networks may comprise a number of computing systems, such as servers, desktops, and laptops. The computing systems may have various storage devices directly attached to the computing systems to facilitate storage of data and installation of applications. In case of any failure in the operation of the computing systems, recovery of the computing systems to a fully functional state may be time consuming as the recovery would involve reinstallation of applications, transfer of data from one storage device to another storage device and so on. To reduce the downtime of the applications affected due to the failure in the computing systems, storage area networks (SANs) are used.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components.

FIG. 1a schematically illustrates a reactive diagnostics system, according to an example of the present subject matter.

FIG. 1b schematically illustrates the reactive diagnostic system in a storage area network (SAN), according to another example of the present subject matter.

FIG. 2 illustrates a graph depicting a topology of a SAN, for performing reactive diagnostics in the SAN, according to an example of the present subject matter.

FIG. 3a illustrates a method for performing reactive diagnostics in a SAN, according to another example of the present subject matter.

FIG. 3b illustrates a method for performing reactive diagnostics in a SAN, according to another example of the present subject matter.

FIG. 4 illustrates a computer readable medium storing instructions for performing reactive diagnostics in a SAN, according to an example of the present subject matter.

### DETAILED DESCRIPTION

SANs are dedicated networks that provide access to consolidated, block level data storage. In SANs, the storage devices, such as disk arrays, tape libraries, and optical jukeboxes, appear to be locally attached to the computing systems rather than connected to the computing systems over a communication network. Thus, in SANs, the storage devices are communicatively coupled with the SANs instead of being attached to individual computing systems.

SANs make relocation of individual computing systems easier as the storage devices may not have to be relocated. Further, upgrade of storage devices is also easier as individual computing systems may not have to be upgraded. Further, in case of failure of a computing system, downtime of affected applications is reduced as a new computing system may be setup without having to perform data recovery and/or data transfer.

SANs are generally used in data centers, with multiple servers, for providing high data availability, ease in terms of scalability of storage, efficient disaster recovery in failure situations, and good input-output (I/O) performance.

The present techniques relate to systems and methods for performing reactive diagnostics in storage area networks (SANs). The methods and the systems as described herein may be implemented using various computing systems.

In the current business environment, there is an ever increasing demand for storage of data. Many data centers use SANs to reduce downtime due to failure of computing systems and provide users with high input-output (I/O) performance and continuous accessibility to data stored in the storage devices connected to the SANs. In SANs, different kinds of storage devices may be interconnected with each other and to various computing systems. Generally, a number of components, such as switches and cables, are used to connect the computing systems with the storage devices in the SANs. In a medium-sized SAN, the number of components which facilitate connection between the computing systems and storage devices may be in the range of thousands. A SAN may also include other components, such as transceivers, also known as Small Form-Factor Pluggable modules (SFPs). These other components usually interconnect the Host Bus Adapters (HBAs) of the computing systems with switches and storage ports. HBAs are those components of computing systems which facilitate I/O processing and connect the computing systems with storage ports and switches over various protocols, such as small computer system interface (SCSI) and serial advanced technology attachment (SATA).

Generally, with time, there is degradation in these components which reduces their performance. Any change in parameters, such as transmitted power, gain and attenuation of the components which adversely affect the performance of the components may be referred to as degradation of the components. Degradation of one or more components in the SANs may reduce the performance of the SANs. For example, degradation may result in a reduced data transfer rate or a higher response time.

Further, different types of components may degrade at different rates and thus can have different lifetimes. For example, cables may have a lifetime of two years, whereas switches may have a lifetime of five years. Since a SAN comprises various types of components and a large number of the various types of components, identifying those components whose degradation may potentially cause failure of the SAN or adversely affect the performance of the SAN is a challenging task. If the degraded components are not replaced in a timely manner, the same may potentially cause failure and result in unplanned downtime or reduce the performance of the SANs.

The systems and the methods described herein implement reactive diagnostics in SANs to identify such degraded components. In one example, the method of reactive diagnostics in SANs is implemented using a reactive diagnostics system. The reactive diagnostics system may be implemented in any computing system, such as personal computers and servers.

In one example, the reactive diagnostics system may determine a topology of the SAN and generate a four-layered graph representing the topology of the SAN. In said example, the reactive diagnostics system may discover devices, such as switches, HBAs and storage devices with SFP Modules in the SAN, and designate the same as nodes. The reactive diagnostics system may use various techniques, such as telnet, simple network management protocol (SNMP), internet control message protocol (ICMP), scanning of internet protocol (IP) address and scanning media access control (MAC) address to discover the devices. The reactive diagnostics system may also detect the connecting elements, such as cables and interconnecting transceivers, between the discovered devices and designate the detected connecting elements as edges. Thereafter, the reactive diagnostics system may generate a first layer of the graph depicting the nodes and the edges where nodes represent devices which may have ports for interconnection with other devices. Examples of such devices include HBAs, switches and storage devices. The ports of the devices designated as nodes may be referred to as node ports. In the first layer, the edges represent connections between the node ports. For the sake of simplicity it may be stated that edges represent connection between devices.

The reactive diagnostics system may then generate the second layer of the graph. The second layer of the graph may depict the components of the nodes and edges, for example, SFP modules and cables, respectively. The second layer of the graph may also indicate physical connectivity infrastructure of the SAN. In one example, the physical connectivity infrastructure comprises the connecting elements, such as the SFP modules and the cables that interconnect the components of the nodes.

The reactive diagnostics system then generates the third layer of the graph. The third layer depicts the parameters that are indicative of the performance of the components depicted in the second layer. These parameters that are associated with the performance of the components may be provided by an administrator of the SAN or by a manufacturer of each component. For example, performance of the components of the nodes, such as switches, may be dependent on parameters of SFP modules in the node ports, such as received power, transmitted power and temperature parameters. Similarly, one of the parameters on which the working or the performance of a cable between two switches is dependent may include attenuation factor of the cable.

Thereafter, the reactive diagnostics system generates the fourth layer of the graph which indicates operations that are to be performed based on the parameters. In one example, the fourth layer may be generated based on the type of the component and the parameters associated with the component. For instance, if the component is a SFP and the parameters associated with the SFP are transmitted power, received power, temperature, supply voltage and transmitted bias, the operation may include testing whether each of these parameters lie within a predefined normal working range. The operations associated with each component may be defined by the administrator of the SAN or by the manufacturer of each component.

The operations may be classified as local node operations and cross node operations. The local node operations may be the operations performed on parameters of a node and an edge which affect the working of the node or the edge. The cross node operations may be the operations that are performed based on the parameters of interconnected nodes.

As explained above, the graph depicting the components and their interconnections as nodes and edges along with parameters indicative of performance of the components is generated. Based on the generated graph, the reactive diagnostics system identifies the parameters indicative of performance of the components. Examples of such parameters of a component, such as a SFP module, may be transmitted power, received power, temperature, supply voltage and transmitted bias. The reactive diagnostics system then monitors the identified parameters to determine degradation in the performance of the components of nodes and edges. In one example, the reactive diagnostics system may read values of the parameters from sensors associated with the components. In another example, the reactive diagnostics system may include sensors to measure the values of the parameters associated with the components.

In operation, an administrator of the SAN may define a range of expected values for each parameter which would indicate that the component is working as expected. The administrator may also define an upper threshold limit and/or a lower threshold limit of values for each parameter. When the value of the each parameter is not within the range as defined by the upper threshold limit and/or the lower threshold limit of values, it would indicate that a component has degraded or has malfunctioned or is not working as expected.

Based on the monitoring of the parameters indicative of performance of a component, if it is detected that the performance of the component has degraded, the reactive diagnostics system may perform reactive diagnostics to determine a root cause of the degradation of the component. In one example, the reactive diagnostics may be performed based on the one or more operations on determining the degradation. The operations may be based on at least one of a local node operation and a cross node operation as defined in the fourth layer of the graph generated based on the topology of the SAN.

In reactive diagnostics, the reactive diagnostics system determines the root cause of degradation of a component and the impact of the degradation on the performance of the SAN. For example, due to degradation of a component, the performance of the SAN may have reduced or a portion of the SAN may not be accessible by the computing systems.

The reactive diagnostics involve performing a combination of local node operations and cross node operations at a component whose performance has been determined to have degraded. In local node operations, the parameters associated with a node may be monitored and analyzed to identify the component whose state has changed, the root cause of change of state of the component, and the impact of the change of state of the component on the performance or working of the SAN. Also, as mentioned earlier, in cross node operations, parameters associated with two or more interconnected nodes may be monitored and analyzed to identify the component whose state has changed, the root cause of change of state of the component, and the impact of the change of state of the component on the performance or working of the SAN.

In one example, the operations to be performed as a part of reactive diagnostics may be based on the topology of the SAN. For example, if, based on the topology of the SAN, it is determined that a node is connected to many other nodes then cross node operations may be performed. Further, the reactive diagnostics may be based on diagnostics rules. The diagnostics rules may be understood as pre-defined rules for determining the root cause of degradation of a component. For example, the administrator of the SAN may define the pre-defined diagnostics rules in any machine readable language, such as extensible markup language (XML).

The reactive diagnostics may be explained considering a SFP module as an example. The example, however, would be applicable to other components of the SAN. In said example, a monitored parameter of a first SFP module may indicate an abnormal state of operation because of degradation of a second SFP module, which is connected to the first SFP module. Thus, the reactive diagnostics system monitors the values of interconnected components, in this case the first and the second SFP modules, to identify the root cause of degradation of a component. The root cause may be identified based on the pre-defined diagnostics rules. For example, a diagnostic rule may define that abnormal received power of a SFP module may indicate degradation of an interconnected SFP module. In one example, the reactive diagnostics system may monitor the status of a port of a switch. A status indicating an error or a fault in the port may be no transceiver present or a laser fault or a port fault. The status of the port may be directly inferred from such status indication, based on diagnostics rules. In another example, a diagnostic rule for local node operations, may define that abnormal transmitted power of a SFP module may indicate that the SFP module may be in a degraded state.

Similarly, in an example, a pre-defined diagnostic rule for cross node operations may state that if the transmitted power of the SFP module is within a range, limited by the upper threshold and the lower threshold of values as defined by the administrator or the component manufacturer, and an interconnected SFP is in a working condition, but the received power by the interconnected SFP module is in an abnormal range, then there might be degradation in the connecting element, such as a cable, for a monitored cable length and associated attenuation. The graph, by depicting the interconnection of nodes and edges, helps in identifying the component that has degraded.

Further, based on the determination of the root cause of the degradation, the reactive diagnostics system may generate a notification in form of an alarm for the administrator. The notification may be indicative of the severity of the impact of the degradation of the component on the performance of the SAN. Thus, the reactive diagnostics system generates messages or notifications for the administrator, helps the administrator to identify the severity of the degradation of the components in a complex SAN, and determine the priority in which the components should be replaced.

The system and method for performing reactive diagnostics in a SAN involve generation of the graph depicting the topology of the SAN, which facilitates easy identification of the degraded component even when the same is connected to multiple other components. This facilitates timely replacement of components which have degraded or have malfunctioned and help in continuous operation of the SAN.

The above systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

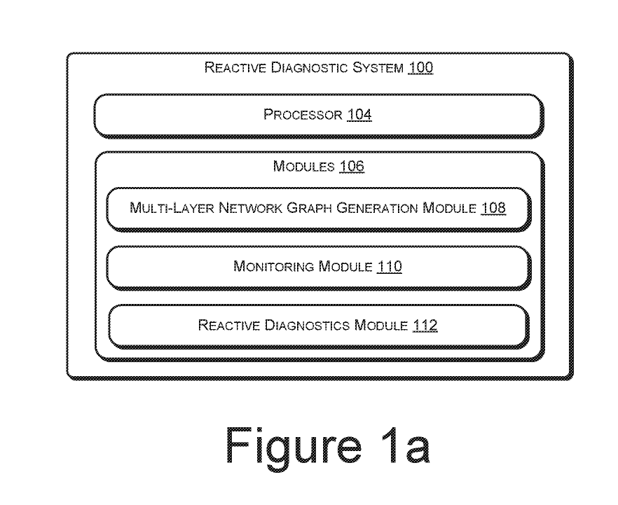

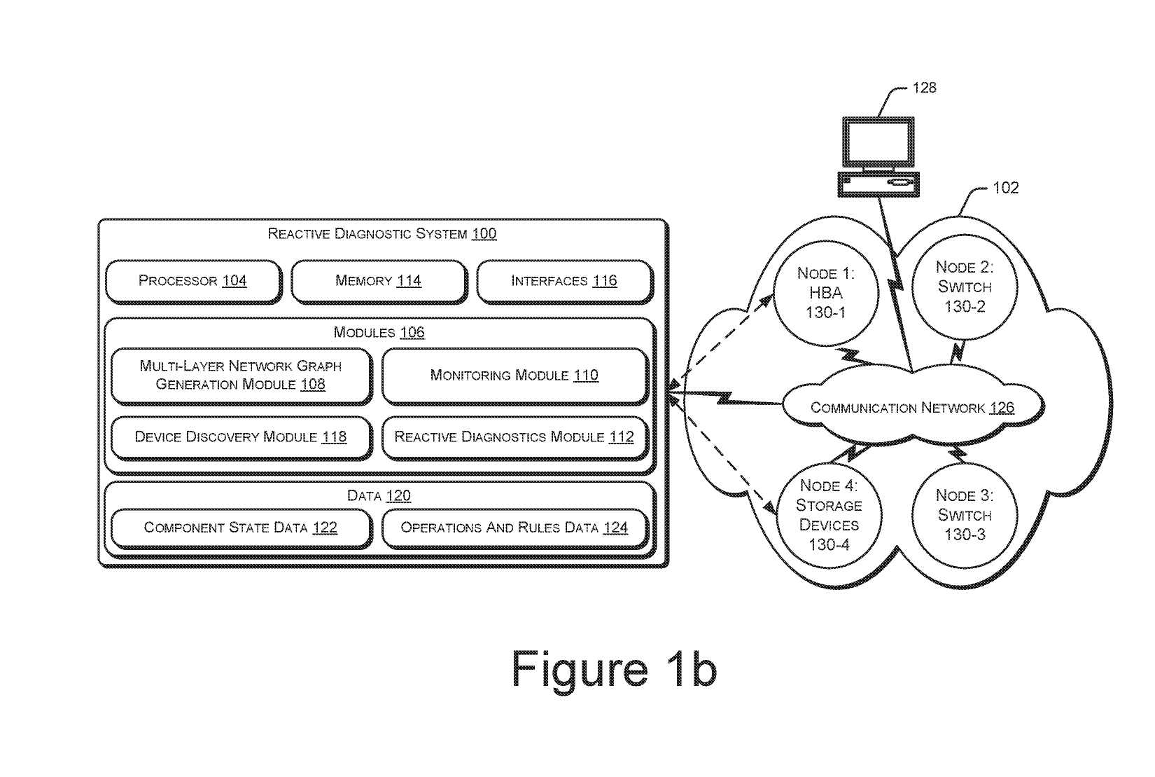

The manner in which the systems and methods for performing reactive diagnostics in a SAN are implemented are explained in details with respect to FIGS. 1a, 1 b, 2, 3a, 3b, and 4. While aspects of described systems and methods for performing reactive diagnostics in a SAN can be implemented in any number of different computing systems, environments, and/or implementations, the examples and implementations are described in the context of the following system(s).

FIG. 1a schematically illustrates the components of a reactive diagnostics system 100 for performing reactive diagnostics in a storage area network (SAN) 102 (shown in FIG. 1b), according to an example of the present subject matter. In one example, the reactive diagnostics system 100 may be implemented as any commercially available computing system.

In one implementation, the reactive diagnostics system 100 includes a processor 104 and modules 106 communicatively coupled to the processor 104. The modules 106, amongst other things, include routines, programs, objects, components, and data structures, which perform particular tasks or implement particular abstract data types. The modules 106 may also be implemented as, signal processor(s), state machine(s), logic circuitries, and/or any other device or component that manipulates signals based on operational instructions. Further, the modules 106 can be implemented by hardware, by computer-readable instructions executed by a processing unit, or by a combination thereof. In one implementation, the modules 106 include a multi-layer network graph generation (MLNGG) module 108, a monitoring module 110 and a reactive diagnostics module 112.

In one example, the MLNGG module 108 generates a graph representing a topology of the SAN. The graph comprises nodes indicative of devices in the SAN and edges indicative of connecting elements between the devices. The graph also depicts one or more operations associated with at least one component of the nodes and edges.

The monitoring module 110, monitors parameters indicative of performance of the at least one component and determines a degradation in the performance of the at least one component. On detecting a degradation in the performance, the reactive diagnostics module 112 performs reactive diagnostics for the at least one component based on the one or more operations identified by the MLNGG module 108 in the graph. In one example, the operations may comprise at least one of a local node operation and a cross node operation, based on the topology of the SAN. The reactive diagnostics performed by the reactive diagnostics system 100 is described in detail in conjunction with FIG. 1b.

FIG. 1b schematically illustrates the various constituents of the reactive diagnostics system 100 for performing reactive diagnostics in the SAN 102, according to another example of the present subject matter. The reactive diagnostics system 100 may be implemented in various computing systems, such as personal computers, servers and network servers.

In one implementation, the reactive diagnostics system 100 includes the processor 104, and the memory 114 connected to the processor 104. Among other capabilities, the processor 104 may fetch and execute computer-readable instructions stored in the memory 114.

The memory 114 may be communicatively coupled to the processor 104. The memory 114 can include any commercially available non-transitory computer-readable medium including, for example, volatile memory, and/or non-volatile memory.

Further, the reactive diagnostics system 100 includes various interfaces 116. The interfaces 116 may include a variety of commercially available interfaces, for example, interfaces for peripheral device(s), such as data input and output devices, referred to as I/O devices, storage devices, and network devices. The interfaces 116 facilitate the communication of the reactive diagnostics system 100 with various communication and computing devices and various communication networks. The interfaces 116 also facilitate the reactive diagnostics system 100 to interact with HBAs and interfaces of storage devices for various purposes, such as for performing reactive diagnostics.

Further, the reactive diagnostics system 100 may include the modules 106. In said implementation, the modules 106 include the MLNGG module 108, the monitoring module 110, a device discovery module 118 and the reactive diagnostics module 112. The modules 106 may also include other modules (not shown in the figure). These other modules may include programs or coded instructions that supplement applications or functions performed by the reactive diagnostics system 100.

In an example, the reactive diagnostics system 100 includes data 120. In said implementation, the data 120 may include component state data 122, operations and rules data 124 and other data (not shown in figure). The other data may include data generated and saved by the modules 106 for providing various functionalities of the reactive diagnostics system 100.

In one implementation, the reactive diagnostics system 100 may be communicatively coupled to various devices or nodes, of the SAN 102, over a communication network 126. Examples of devices in the SAN 102 to which the reactive diagnostics system 100 is communicatively coupled, as depicted in FIG. 1b, may be a node1, representing a HBA 130-1, a node2, representing a switch 130-2, a node3, representing a switch 130-3, and a node4, representing storage devices 130-4. The reactive diagnostics system 100 may also be communicatively coupled to various client devices 128, which may be implemented as personal computers, workstations, laptops, netbook, smart-phones and so on, over the communication network 126. The client devices 128 may be used by an administrator of the SAN 102 to perform various operations, such as input an upper threshold limit and/or a lower threshold limit of values of each parameter of each component. In one example, the values of the upper threshold limit and/or lower threshold limit may be provided by the manufacturer of the each component.

The communication network 126 may include networks based on various protocols, such as gigabit Ethernet, synchronous optical networking (SONET), Hypertext Transfer Protocol (HTTP) and Transmission Control Protocol/Internet Protocol (TCP/IP).

In operation, the device discovery module 118 may use various mechanisms, such as Simple Network Management Protocol (SNMP), Web Service (WS) discovery, Low End Customer device Model (LEDM), bonjour, Lightweight Directory Access Protocol (LDAP)-walkthrough to discover the various devices connected to the SAN 102. As mentioned before, the devices are designated as nodes 130. Each node 130 may be uniquely identified by a unique node identifier, such as the MAC address of the node or the IP address of the node 130 or serial number in case the node 130 is a SFP module. The device discovery module 118 may also discover the connecting elements, such as cables, as edges between two nodes 130. In one example, each connecting element may be uniquely identified by the port numbers of the nodes 130 at which the connecting element terminates.

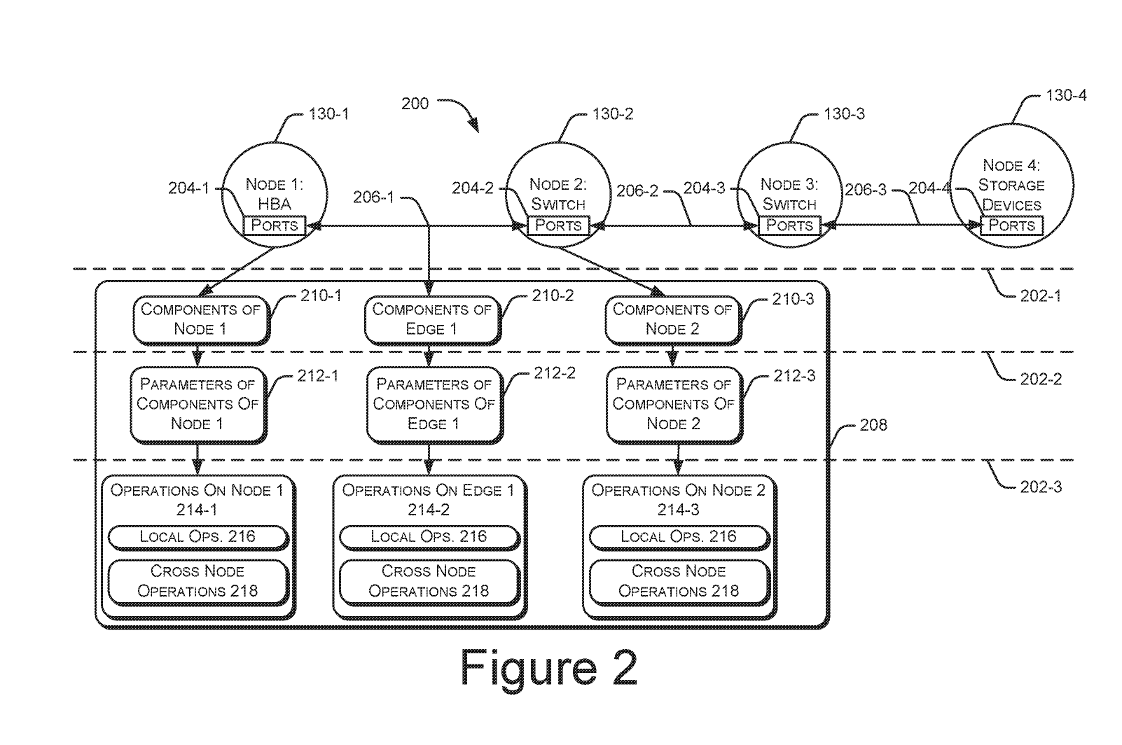

Based on the discovered nodes 130 and edges, the MLNGG module 108 may determine the topology of the SAN 102 and generate a four layered graph depicting the topology of the SAN 102. The generation of the four layered graph is described in detail in conjunction with FIG. 2.

Based on the generated graph, the monitoring module 110 identifies parameters on which the functioning of a component of a node 130 or a node 130 or an edge is dependent. In an example, such a component may be considered to be an optical SFP module with parameters such as transmitted power, received power, temperature, supply voltage and transmitted bias. The monitoring module 110 monitors values of the identified parameters. In one example, the monitoring module 110 compares the monitored values of the parameters with the upper threshold limit and/or the lower threshold limit of expected values for the parameters for each component. In one example, the administrator of the SAN may have defined the upper threshold limit and/or the lower threshold limit for each parameter. If the value of the each parameter is less than the upper threshold limit and is greater than the lower threshold limit, then the value indicates that the component is in a normal working condition, i.e., working normally or as expected. The administrator or the component manufacturer may also define an upper threshold and/or a lower threshold of values of normal working condition for each parameter. If the value of a parameter exceeds the upper threshold or is less than the lower threshold, then such value indicates that a component has degraded or has malfunctioned or is not working as expected.

Further, severity of the degradation of the component may be determined by the reactive diagnostics module 112 based on an impact of the degradation on the performance of the SAN. Based on this determination, the monitoring module 110 may generate a notification, for an administrator of the SAN to indicate the severity of the degradation to the administrator. In one example, the administrator may further define the thresholds of values that indicate that the severity of the degradation of the component is such that it may impact the performance of the SAN and if such a value is attained, the reactive diagnostics system 100 generates alarms for the administrator. In one example, the threshold values, defined by the administrator or published by a component manufacturer, may be saved as component state data 122.

Table 1 shows an example of threshold values defined by the administrator or component manufacturer for a component, such as the SFP module. In one example, the upper threshold and/or lower threshold of values for each parameter which would indicate that a component has degraded or has malfunctioned may be stored as component state data 122.

TABLE 1

| | Range | | Notification to |
|---|---|---|---|
| Parameter | Lower Threshold | Upper Threshold | be generated |
| Voltage | 2.9 Volts | 3.6 Volts | Normal Working |
| | 2.8 Volts | 2.9 Volts | Low Warning |
| | 3.6 Volts | 3.8 Volts | High Warning |
| | Not applicable | 2.8 Volts | Low Alarm |
| | 3.8 Volts | Not applicable | High Alarm |
| Transmission | −10 | −1.549 | Normal Working |
| Power (in | −13.010 | 10 | Low Warning |
| decibels) | −1.549 | −0.969 | High Warning |
| | Not applicable | −13.010 | Low Alarm |
| | −0.969 | Not applicable | High Alarm |

When the monitoring module 110 detects that at least one of the monitored parameters is outside a predefined range of expected values, which indicates normal working of the component, the monitoring module 110 may determine degradation in the performance of the component and generate a notification for the administrator. In one example, the monitoring module 110 may generate warnings and alarms, based on the variance of the value of parameter from its expected range of values. The monitoring module 110 may also activate the reactive diagnostics module 112 so as to perform reactive diagnostics for the component. The reactive diagnostics performed in the SAN are based on the graph depicting the topology of the SAN.

On being activated, the reactive diagnostics module 112 performs reactive diagnostics to determine the root cause of degradation or change in state of a component and the impact of said degradation of the component on performance of the SAN. In one example, the reactive diagnostics module 112 may determine whether, due to change in state of a component, the performance of the SAN is reduced or whether a portion of the SAN may not be accessible by the computing devices, such as the client devices 128. Based on the impact, the reactive diagnostics module 112 may determine the severity of the degradation of the component and generate a notification, for an administrator of the SAN 102 indicating the severity of the degradation. This helps the administrator of the SAN 102 in prioritizing the replacement of the degraded components. For example, degradation of a first component increases the response time of the SAN 102 by 5%, whereas degradation of a second component makes a portion of the SAN 102 inaccessible. Based on pre-defined diagnostics rules, the reactive diagnostics module 112 may classify the degradation of the second component to be more severe than degradation of the first component and generate a notification for the administrator accordingly. Thus, the reactive diagnostics module 112 identifies the severity of the degradation based on operations depicted in the fourth layer of the graph. The operations depicted in the fourth layer of the graph are associated with parameters which are depicted in the third layer of the graph. The parameters are in turn associated with components, which are depicted in the second layer of the graph, of nodes and edges depicted in the first layer of the graph. Thus, the operations associated with the fourth layer are linked with the nodes and edges of the first layer depicted in the graph.

In one example, the reactive diagnostics module 112 may perform reactive diagnostics based on diagnostics rules. In one example, the diagnostics rules define whether local node operations or cross node operations or a combination of the two should be carried out based on the topology of the SAN. To elaborate, the component for which the reactive diagnostics is being performed is present in the second layer of the graph depicting the topology of the SAN. The topology in the graph further includes the parameters associated with the performance of the component and the operations to be performed on the component in the subsequent layers. Thus, based on the topology, the diagnostics rules may specify the operations for performing reactive diagnostics for a particular component.

As explained previously, the operations may be a combination of local node operations and cross node operations. In cross node operations, the reactive diagnostics module 112 may analyze the values of the parameters associated with two or more interconnected nodes to identify the component whose state has changed, identify the root cause of change of state of the component, and determine the impact of the change of state of the component on the performance or working of the SAN 102. For example, the administrator of the SAN 102 may define the pre-defined diagnostics rules in any machine readable language, such as extensible markup language (XML). In one example, the pre-defined diagnostics rules may be stored as operations and rule data 128.

The working of the reactive diagnostics module 112 is further explained in the context of a SFP module associated with the node 130. In one example, a monitored parameter of a first SFP module may indicate an abnormal state of operation because of degradation of a second SFP module, which is interconnected to the first SFP module. In said example, the reactive diagnostics module 112, based on the values of the parameters of the interconnected components, in this case SFP modules, may identify the root cause of change of state of a component as degradation of the second SFP module. As apparent in this case, an example of a pre-defined diagnostic rule may be that abnormal received power of the SFP module may indicate degradation of an interconnected SFP module. Another example of a pre-defined diagnostic rule indicating cross node operations is that if the transmitted power of the SFP module is within a pre-defined range and an interconnected SFP is in a good condition but the received power by the interconnected SFP module is in an abnormal range, then there might be a degradation in the connecting element, such as a cable, for a monitored cable length and associated attenuation. Hence, the reactive diagnostics module 112 may identify the root cause based on the pre-defined diagnostics rules defined by the administrator. Based on the identification of the root cause, degraded components may be repaired or replaced.

Thus, the reactive diagnostics system 100 generates a graph depicting the topology of the SAN 102 which facilitates easy identification of the degraded component even when the same is connected to multiple other components. This facilitates timely replacement of components which have degraded or have malfunctioned and help in continuous operation of the SAN 102.

FIG. 2 illustrates a graph 200 depicting the topology of a storage area network, such as the SAN 102, for performing reactive diagnostics, according to an example of the present subject matter. In one example, the MLNGG module 108 determines the topology of the SAN 102 and generates the graph 200 depicting the topology of the SAN 102. As mentioned earlier, the device discovery module 118 uses various mechanisms to discover devices, such as switches, HBAs and storage devices, in the SAN and designates the same as nodes 130-1, 130-2, 130-3 and 130-4. Each of the nodes 130-1, 130-2, 130-3 and 130-4 may include ports, such as ports 204-1, 204-2, 204-3 and 204-4, respectively, which facilitates interconnection of the nodes 130. The ports 204-1, 204-2, 204-3 and 204-4 are henceforth collectively referred to as the ports 204 and singularly as the port 204.

The device discovery module 118 may also detect the connecting elements 206-1, 206-2 and 206-3 between the nodes 130 and designate the detected connecting elements 206-1, 206-2 and 206-3 as edges. Examples of the connecting elements 206 include cables and optical fibers. The connecting elements 206-1, 206-2 and 206-3 are henceforth collectively referred to as the connecting elements 206 and singularly as the connecting element 206.

Based on the discovered nodes 130 and edges, the MLNGG module 108 generates a first layer of the graph 200 depicting discovered nodes 130 and edges and the interconnection between the nodes 130 and the edges. In FIG. 2, the portion above the line 202-1 depicts the first layer of the graph 200.

In one example, the second, third and fourth layers of the graph 200 beneath the interconnection of ports of two adjacent nodes 130 are collectively referred to as a Minimal Connectivity Section (MCS) 208, As depicted in FIG. 2, the three layers beneath Node1 130-1 and Node2 130-2 are the MCS 208. Similarly, the three layers beneath Node2 130-2 and Node3 130-3 is also another MCS (not depicted in figure).

The MLNGG module 108 may then generate the second layer of the graph 200 to depict components of the nodes and the edges. The portion of the graph 200 between the lines 202-1 and 202-2 depicts the second layer. In one example, the MLNGG module 108 discovers the components 210-1 and 210-3 of the Node1 130-1 and the Node2 130-2, respectively. The components 210-1, 210-2 and 210-3 are collectively referred to as the components 210 and singularly as the component 210.

The MLNGG module 108 also detects the components 210-2 of the edges, such as the edge representing the connecting element 206-1 depicted in the first layer. An example of such components 210 may be cables. In another example, the MLNGG module 108 may retrieve a list of components 210 for each node 130 and edge from a database maintained by the administrator, Thus, the second layer of the graph may also indicate physical connectivity infrastructure of the SAN 102.

Thereafter, the MLNGG module 108 generates the third layer of the graph. The portion of the graph depicted between the lines 202-2 and 202-3 is the third layer. The third layer depicts the parameters of the components of the node1 212-1, parameters of the components of edge1 212-2, and so on. The parameters of the components of the node1 212-1 and parameters of the components of edge1 212-2 are parameters indicative of performance of node1 and edge1, respectively. The parameters of the components of the node1 212-1, the parameters of the components of the edge1 212-2 and parameters 212-3 are collectively referred to as the parameters 212 and singularly as parameter 212. Examples of parameters 212 may include temperature of the component, received power by the component, transmitted power by the component, attenuation caused by the component and gain of the component.

In one example, the MLNGG module 108 determines the parameters 212 on which the performance of the components 210 of the node 130, such as SFP modules, may be dependent on. Examples of such parameters 212 may include received power, transmitted power and gain. Similarly, the parameters 212 on which the performance or the working of the edges, such as a cable between two switch ports, is dependent on may be length of the cable and attenuation of the cable.

The MLNGG module 108 also generates the fourth layer of the graph. In FIG. 2, the portion of the graph 200 below the line 202-3 depicts the fourth layer. The fourth layer indicates the operations on node1 214-1 which may be understood as operations to be performed on the components 210-1 of the node1 132-1. Similarly operations on edge1 214-2 are operations to be performed on the components 210-2 of the connecting element 206-1 and operations on node2 214-3 are operations to be performed on the components 210-3 of the node2 132-2. The operations 214-1, 214-2 and 214-3 are collectively referred to as the operations 214 and singularly as the operation 214.

As mentioned earlier, the operations 214 may be classified as local node operations 216 and cross node operations 218. The local node operations 216 may be the operations, performed on one of a node 130 and an edge, which affect the working of the node 130 or the edge. The cross node operations 218 may be the operations that are performed based on the parameters of the interconnected nodes, such as the nodes 130-1 and 130-2, as depicted in the first layer of the graph 200. In one example, the operations 214 may be defined for each type of the components 210. For example, local node operations 216 and cross node operations 218 defined for a SFP module may be application to all SFP modules. This facilitates abstraction of the operations 214 from the components 210.

The graph 200 thus depicts the topology of the SAN and shows the interconnection between the nodes 130 and connecting elements 206. This helps in performing cross node operations 218 on the interconnected nodes 130 and connecting elements 206. Thus the graph 200 facilitates root cause analysis on detecting degradation in any component of the SAN.

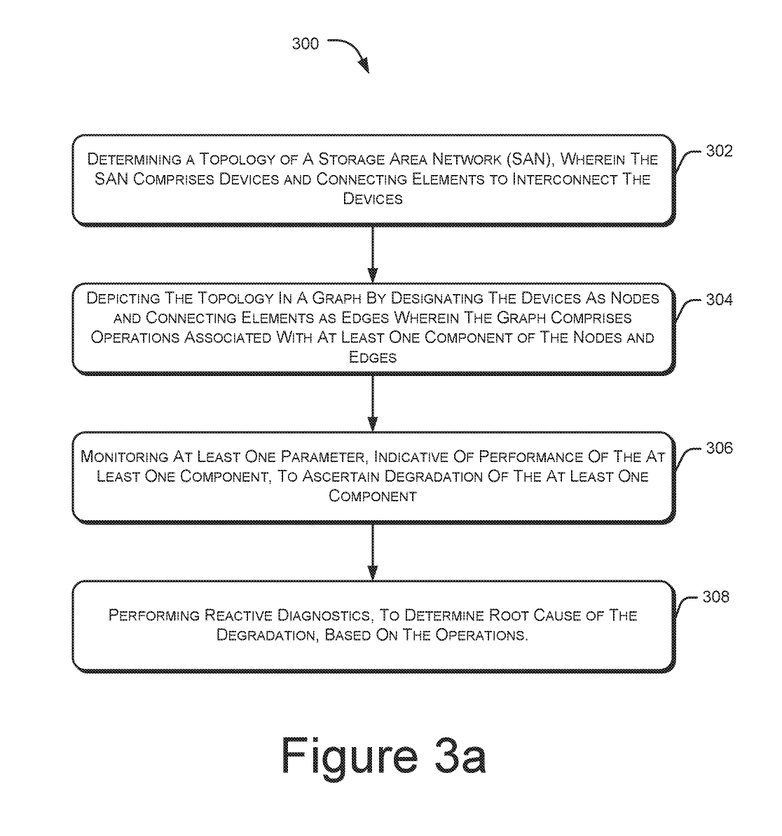

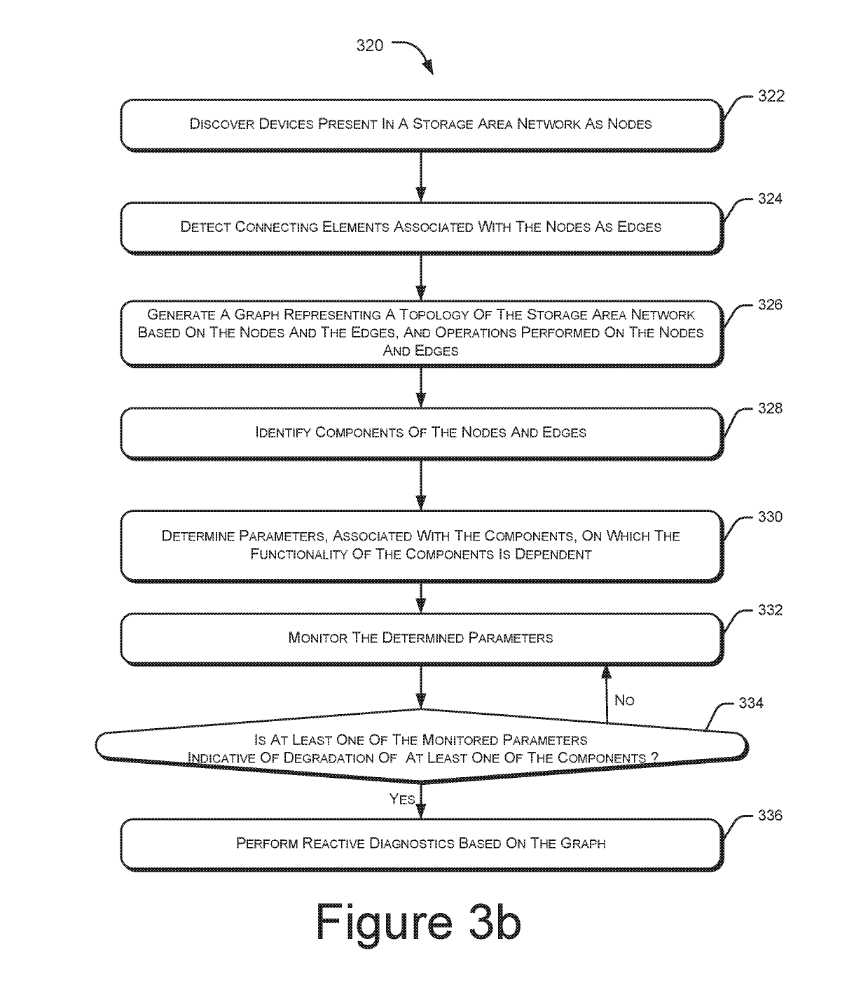

FIGS. 3a and 3b illustrate methods 300 and 320 for performing reactive diagnostics in a storage area network, according to an example of the present subject matter. The order in which the methods 300 and 320 are described is not intended to be construed as a limitation, and any number of the described method blocks can be combined in any order to implement the methods 300 and 320, or an alternative method. Additionally, individual blocks may be deleted from the methods 300 and 320 without departing from the spirit and scope of the subject matter described herein. Furthermore, the methods 300 and 320 may be implemented in any suitable hardware, computer-readable instructions, or combination thereof.

The steps of the methods 300 and 320 may be performed by either a computing device under the instruction of machine executable instructions stored on a storage media or by dedicated hardware circuits, microcontrollers, or logic circuits. Herein, some examples are also intended to cover program storage devices, for example, digital data storage media, which are machine or computer readable and encode machine-executable or computer-executable programs of instructions, where said instructions perform some or all of the steps of the described methods 300 and 320. The program storage devices may be, for example, digital memories, magnetic storage media, such as a magnetic disks and magnetic tapes, hard drives, or optically readable digital data storage media.

With reference to method 300 as depicted in FIG. 3a, as depicted in block 302, a topology of the SAN 102 is determined. As mentioned earlier, the SAN 102 comprises devices and connecting elements to interconnect the devices. In one implementation, the MLNGG module 108 determines the topology of the SAN 102.

As shown in block 304, the topology of the SAN 102 is depicted in form of a graph. The graph is generated by designating the devices as nodes 130 and connecting elements as edges. The graph further comprises operations associated with at least one component of the nodes and edges. In one example, the monitoring module 110 generates the graph 200 depicting the topology of the SAN 102.

At block 306, at least one parameter, indicative of performance of at least one component, is monitored to ascertain degradation of the at least one component. The at least one component may be of a device or a connecting element. In one example, the monitoring module 110 may monitor the at least one parameter, indicative of performance of at least one component, by measuring the values of the at least one parameter or reading the values of the at least one parameter from sensors associated with the at least one component.

At block 308, reactive diagnostics is performed to determine root cause of the degradation, based on the operations. In one example, the reactive diagnostics module 112 perform reactive diagnostics to determine the root cause based on diagnostics rules or a combination of local node operations and cross node operations.

FIG. 3b illustrates a method 320 for a method for performing reactive diagnostics in a storage area network, according to another example of the present subject matter. With reference to method 320 as depicted in FIG. 3b, at block 322, the devices present in a storage area network are discovered and designated as nodes. In one example, the device discovery module 118 may discover the devices present in a storage area network and designate them as nodes.

As illustrated in block 324, the connecting elements associated with the nodes are detected as edges. In one example, the device discovery module 118 may discover the connecting elements, such as cables, associated with the discovered devices. In said example, the connecting elements are designated as edges.

As shown in block 326, a graph representing a topology of the storage area network is generated based on the nodes and the edges, and operations performed on the nodes and edges. In one example, the MLNGG module 108 generates a four layered graph depicting the topology of the SAN 102 based on the detected nodes and edges.

At block 328, components of the nodes and edges are identified. In one example, the monitoring module 110 may identify the components of the nodes and edges. Examples of components of nodes may include ports, sockets, power supply unit, cooling unit and sensors.

At block 330, the parameters, associated with the components, on which the functionality of the components is dependent, are determined. In one example, the monitoring module 110 may identify the parameters based on which the performance or the functioning of a component is dependent. Examples of such parameters include received power, transmitted power, supply voltage, temperature, and attenuation.

As illustrated in block 332, the determined parameters are monitored. In one example, the monitoring module 110 may monitor the determined parameters by measuring the values of the determined parameters or reading the values of parameters from sensors associated with the components. The monitoring module 110 may monitor the determined parameters either continuously or at regular time intervals, for example every three hundred seconds.

At block 334, it is determined whether at least one of the monitored parameters is indicative of degradation of at least one of the components, i.e., whether the value of at least one of the monitored parameters is outside a predefined range. In one example, the monitoring module 110 may determine whether the measured values of a parameter is within a pre-defined expected range of values for said parameter.

If at block 334, it is determined that the measured value of each of the monitored parameters are within the expected range of values for each said parameter, then, as shown in block 332, the monitoring of the determined parameters is continued.

If at block 334, it is determined that the measured value of at least one of the monitored parameters is outside the expected range of values for said parameter, then, as shown in block 336, reactive diagnostics is performed based on the graph depicting the topology of the SAN. In one example, the reactive diagnostics module may perform reactive diagnostics based on a combination of local node operations and cross node operations to determine the root cause of degradation or failure of a component.

Thus, the methods 300 and 320, for performing reactive diagnostics in the SAN 102 facilitates easy identification of the degraded component and in turn helps in quick identification of the degraded component even when the same is connected to multiple other components. This facilitates timely replacement of components which have degraded or have malfunctioned and help in continuous operation of the SAN.

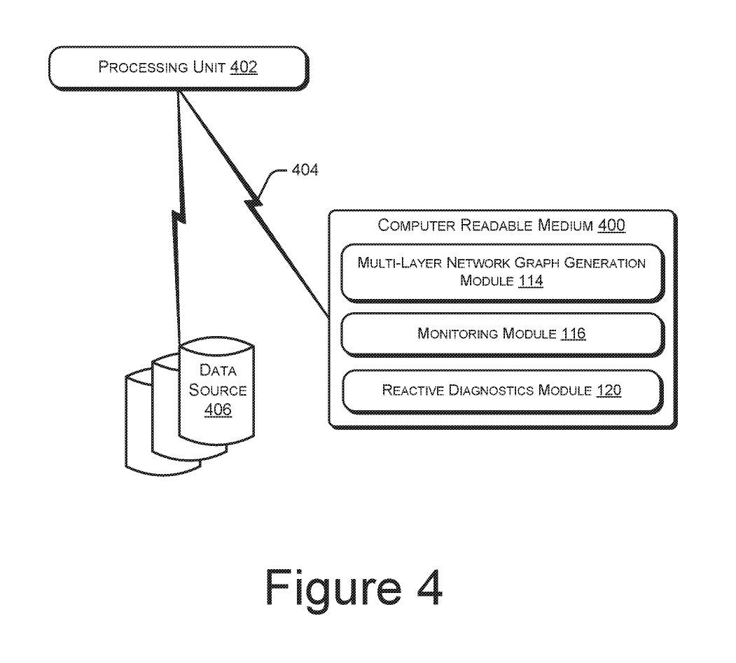

FIG. 4 illustrates a computer readable medium 400 storing instructions for performing reactive diagnostics in a storage area network, according to an example of the present subject matter. In one example, the computer readable medium 400 is communicatively coupled to a processing unit 402 over communication link 404.

For example, the processing unit 402 can be a computing device, such as a server, a laptop, a desktop, a mobile device, and the like. The computer readable medium 400 can be, for example, an internal memory device or an external memory device, or any commercially available non transitory computer readable medium. In one implementation, the communication link 404 may be a direct communication link, such as any memory read/write interface. In another implementation, the communication link 404 may be an indirect communication link, such as a network interface. In such a case, the processing unit 402 can access the computer readable medium 400 through a network.

The processing unit 402 and the computer readable medium 400 may also be communicatively coupled to data sources 406 over the network. The data sources 406 can include, for example, databases and computing devices. The data sources 406 may be used by the requesters and the agents to communicate with the processing unit 402.

In one implementation, the computer readable medium 400 includes a set of computer readable instructions, such as the MLNGG module 108, the monitoring module 110 and the reactive diagnostics module 112. The set of computer readable instructions can be accessed by the processing unit 402 through the communication link 404 and subsequently executed to perform acts for performing reactive diagnostics in a storage area network.

On execution by the processing unit 402, the MLNGG module 108 determines a topology of the SAN 102, which comprises devices and connecting elements to interconnect the devices. Thereafter, the MLNGG module 108 depicts the topology in form of a graph. In the graph, the devices are designated as nodes and the connecting elements 206 associated with the devices are designated as edges. The graph further depicts the operations associated with at least one component of the nodes and edges. Thereafter, the monitoring module 108 monitors at least one parameter, indicative of performance of the at least one component to ascertain degradation of the at least one component. On determining degradation of the at least one component, the reactive diagnostics module 112 performs reactive diagnostics, to determine root cause of the degradation, based on the operations.

Although implementations for performing reactive diagnostics in a storage area network have been described in language specific to structural features and/or methods, it is to be understood that the appended claims are not necessarily limited to the specific features or methods described. Rather, the specific features and methods are disclosed as examples of systems and methods for performing reactive diagnostics in a storage area network.

I/We claim:

1. A system for performing reactive diagnostics in a storage area network (SAN) comprising:
a processor;
a mufti-layer network graph generation (MLNGG) module; coupled to the processor, to generate a graph representing a topology of the SAN, the graph comprising nodes indicative of devices in the SAN, edges indicative of connecting elements between the devices, and one or more operations associated with at least one component of the nodes and edges;
a monitoring module, coupled to the processor, to:
monitor at least one parameter indicative of performance of the at least one component; and
determine a degradation in performance of the at least one component; and
a reactive diagnostics module; coupled to the processor, to perform, on determining the degradation, reactive diagnostics to determine a root cause of the degradation based on the one or more operations, wherein the one or more operations is based on the topology of the SAN.

2. The system of claim 1, wherein the MLNGG module further to:
identify the nodes and the edges in the SAN to create a first layer of the graph;
determine components of the nodes and the edges to create a second layer of the graph;
ascertain parameters of the components to create a third layer of the graph, wherein the parameters are associated with functioning of the components; and
identify the operations to be performed on the nodes and the edges to create a fourth layer of the graph.

3. The system of claim 1, wherein the reactive diagnostics module to perform reactive diagnostics based on at least one diagnostics rule and wherein the at least one diagnostics rule defines performing one or more of a local node operation and a cross-node node operation based on the topology of the SAN.

4. The system of claim 1, wherein the monitoring module to compare values associated with the at least one parameter with at least one of an upper threshold limit and a lower threshold limit defined for the at least one parameter, to determine the degradation.

5. The system of claim 3, wherein the reactive diagnostics module to further determines a severity of the degradation, based on an impact of the degradation on performance of the SAN; and wherein, the monitoring module to further generate a notification, for an administrator of the SAN, indicating the severity of the degradation.

6. A method for performing reactive diagnostics in a storage area network (SAN), the method comprising:
determining a topology of the SAN, the SAN comprising devices and connecting elements to interconnect the devices;
depicting the topology in a graph, wherein the graph designates the devices as nodes and the connecting elements as edges, and wherein the graph comprises operations associated with at least one component of the nodes and edges;
monitoring at least one parameter indicative of performance of the at least one component to ascertain degradation of the at least one component; and
performing reactive diagnostics for of the at least one component, to determine root cause of the degradation, based on the operations.

7. The method of claim 6, wherein the operations comprise local node operation (216) and the cross-node node operation.

8. The method of claim 6, wherein the depicting further comprises:
identifying the nodes and the edges in the SAN to create a first layer of the graph;
determining components of the nodes and the edges to create a second layer of the graph;
ascertaining parameters of the components to create a third layer of the graph, wherein the parameters are associated with functioning of the components; and
identifying the operations to be performed on the nodes and edges to create a fourth layer of the graph.

9. The method of claim 6, further comprises discovering the devices communicatively coupled to the SAN and the connecting elements present in the SAN based on at least one of telnet, simple network management protocol (SNMP), internet control message protocol (ICMP), scanning of internet protocol (IP) address and scanning media access control (MAC) address.

10. The method of claim 7, wherein the determining of the root cause of the degradation is based on at least one of diagnostics rules and a combination of the local node operation and the cross-node node operation.

11. The method of claim 6, the method further comprises determining the impact of the degradation of the at least one component on performance of the SAN.

12. The method of claim 10, the method further comprises generating an alarm for an administrator of the SAN based on the degradation of the at least one component.

13. A non-transitory computer-readable medium having a set of computer readable instructions that, when executed, cause a reactive diagnostics system to:
determine a topology of a storage area network (SAN), the SAN comprising devices and connecting elements to interconnect the devices;
depict the topology in a graph, wherein the graph designates the devices as nodes and the connecting elements as edges wherein the graph comprises operations associated with at least one component of the nodes and edges;
monitor at least one parameter, indicative of performance of the at least one component to ascertain degradation of the at least one component; and
perform reactive diagnostics to determine root cause of the degradation, based on the operations.

14. The non-transitory computer-readable medium of claim 13 wherein the execution of the set of computer readable instructions further cause the reactive diagnostics system to:
identify the nodes and the edges in the SAN to create a first layer of the graph;
determine components of the nodes and the edges to create a second layer of the graph;
ascertain parameters of the components to create a third layer of the graph, wherein the parameters are associated with functioning of the components; and
identify the operations to be performed on the nodes and edges to create a fourth layer of the graph.

15. The non-transitory computer-readable medium of claim 13 wherein the execution of the set of computer readable instructions further cause the reactive diagnostics system to discover the devices communicatively coupled to the SAN and the connecting elements present in the SAN based on at least one of telnet, simple network management protocol (SNMP), internet control message protocol (ICMP), scanning of internet protocol (IP) address and scanning media access control (MAC) address.
